(19) United States
(12) Patent Application Publication
(10) Pub. No.: US 2024/0221250 A1
(43) Pub. Date: Jul. 4, 2024

(54) METHODS, SYSTEMS AND COMPUTER STORAGE MEDIUMS FOR IMAGE PROCESSING

(71) Applicant: SHANGHAI UNITED IMAGING HEALTHCARE CO., LTD., Shanghai (CN)

(72) Inventors: Le YANG, Shanghai (CN); Na ZHANG, Shanghai (CN); Yang HU, Shanghai (CN)

(73) Assignee: SHANGHAI UNITED IMAGING HEALTHCARE CO., LTD., Shanghai (CN)

(21) Appl. No.: 18/604,480

(22) Filed: Mar. 13, 2024

Related U.S. Application Data
(63) Continuation of application No. PCT/CN2022/128365, filed on Oct. 28, 2022.

(30) Foreign Application Priority Data
Oct. 29, 2021 (CN) 202111275260.6

(51) Int. Cl. G06T 11/00; G06T 5/50

(52) U.S. Cl. CPC G06T 11/008; G06T 5/50; G06T 11/006; G06T 2207/10016; G06T 2207/10081; G06T 2207/10116; G06T 2207/20221; G06T 2207/30068; G06T 2210/41; G06T 2211/421

(57) ABSTRACT

The embodiments of the present disclosure provide methods, systems and computer storage mediums for processing an image. The method may include: obtaining a plurality of projection images generated at a plurality of angles; reconstructing, based on the plurality of projection images, a plurality of tomographic images of a plurality of slices; and obtaining a target image sequence based on the plurality of tomographic images of the plurality of slices, wherein the target image sequence including one or more fusion images, and the one or more fusion images are generated based on one or more tomographic images of the plurality of tomographic images corresponding to one or more slices of the plurality of slices.

### CROSS-REFERENCE TO RELATED APPLICATIONS

This application is a Continuation of International Application No. PCT/CN2022/128365 filed on Oct. 28, 2022, which claims priority to Chinese Patent Application No. 202111275260.6, filed on Oct. 29, 2021, the entire contents of which are hereby incorporated by reference.

### TECHNICAL FIELD

The present disclosure generally relates to the field of image reconstruction technology, and in particular, to methods, systems, and computer storage mediums for image processing.

### BACKGROUND

In a digital breast tomosynthesis (DBT) device, sequential scanning may be performed at certain angles in a process of taking a breast tomographic image to obtain a set of projection data of different angles. The projection data may be reconstructed using corresponding algorithm(s) to obtain DBT tomographic images. However, due to a large count of the DBT tomographic images, workload of a doctor who reads the images may increase. At the same time, a two-dimensional (2D) plain image may be usually referred to in order to draw a more accurate diagnostic conclusion when the tomographic images are read. In the process, it is generally required to take the 2D plain image, and the efficiency of image reading is relatively low.

Therefore, it is desirable to provide methods for image processing to improve image reading efficiency and help doctor(s) to better locate a lesion.

### SUMMARY

In one aspect of the present disclosure, a method for image processing is provided. The method may be implemented on at least one machine each of which has at least one processor and at least one storage device for image processing. The method may include: obtaining a plurality of projection images generated at a plurality of angles; reconstructing, based on the plurality of projection images, a plurality of tomographic images of a plurality of slices; and obtaining a target image sequence based on the plurality of tomographic images of the plurality of slices, wherein the target image sequence including one or more fusion images, and the one or more fusion images are generated based on one or more tomographic images of the plurality of tomographic images corresponding to one or more slices of the plurality of slices.

In some embodiments, each fusion image of the one or more fusion images may be generated by fusing an intermediate image corresponding to a slice of the one or more slices and a reference image corresponding to the slice.

In some embodiments, obtaining the one or more fusion images may include: for each slice of the one or more slices, determining one or more mapping images of one or more projection images at one or more target angles of the plurality of angles in the slice; determining, based on the one or more mapping images, a reference image corresponding to the slice; and determining, based on the intermediate image of the slice and the reference image of the slice, a fusion image corresponding to the slice.

In some embodiments, the determining, based on the one or more mapping images, a reference image corresponding to the slice may include: determining an average value or a weighted sum of one or more pixel values of one or more pixels at a same position in the one or more mapping images; and designating the average value or the weighted sum as a pixel value of a pixel at the same position in the reference image.

In some embodiments, the determining, based on the intermediate image of the slice and the reference image of the slice, a fusion image corresponding to the slice may include: determining an image generated by fusing the intermediate image of the slice and the reference image of the slice according to a preset ratio as the fusion image corresponding to the slice.

In some embodiments, the determining one or more mapping images of one or more projection images at one or more target angles of the plurality of angles in the slice may include: determining the one or more mapping images of the one or more projection images at the one or more target angles in the slice using a filtering and/or a back-projection algorithm.

In some embodiments, obtaining the target image sequence may include: determining, according to a generation order in which the plurality of tomographic images of the plurality of slices are generated in reconstruction, an initial slice; and designating the fusion image corresponding to the initial slice as an initial image of the target image sequence.

In some embodiments, the determining, according to a generation order in which the plurality of tomographic images of the plurality of slices are generated in reconstruction, an initial slice may include: designating a slice corresponding to a tomographic image generated earliest or latest in the reconstruction of the plurality of tomographic images of the plurality of slices as the initial slice.

In some embodiments, obtaining the target image sequence may further include: according to a positive order or a reverse order of the generation order in which the plurality of tomographic images of the plurality of slices are generated in the reconstruction, for a current slice other than the initial slice in the plurality of slices, determining one or more target slices between the initial slice and the current slice; and generating the target image sequence by combining one or more fusion images corresponding to the one or more target slices.

In some embodiments, the determining one or more target slices between the initial slice and the current slice may include: designating all slices between the initial slice and the current slice as the one or more target slices; or designating one or more slices between the initial slice and the current slice as the one or more target slices, a count of the one or more slices being not exceeding a preset number.

In some embodiments, determining the one or more intermediate images may include: for each slice of the one or more slices, obtaining the intermediate image corresponding to the current slice by performing a maximum intensity projection operation on tomographic image corresponding to the current slice.

In some embodiments, determining the one or more intermediate images may include: for each slice of the one or more slices, determining the current slice as a updated initial slice; obtaining a maximum intensity projection image corresponding to the current slice by performing a maximum intensity projection operation on the tomographic image corresponding to the updated initial slice; obtaining the intermediate image corresponding to a previous slice of the current slice; and obtaining the intermediate image corresponding to the current slice by fusing the intermediate image corresponding to the previous slice and the maximum intensity projection image corresponding to the updated initial slice.

In some embodiments, the one or more target angles may include a first angle corresponding to a vertical direction of the plurality of slices, a second angle and a third angle. The second angle may be a left adjacent angle of the first angle. The third angle may be a right adjacent angle of the first angle.

In some embodiments, the plurality of projection images may be acquired by a digital breast tomosynthesis (DBT) device.

In some embodiments, the method for processing an image may further include processing the plurality of projection images.

In some embodiments, the processing may include at least one of image segmentation, grayscale transformation, or window width and window level adjustment.

In some embodiments, the fusing process of the one or more tomographic images of the plurality of tomographic images corresponding to the one or more slices of the plurality of slices may be performed simultaneously with the reconstructing process of the plurality of tomographic images of the plurality of slices.

In another aspect of the present disclosure, a system for image processing is provided. The system may include at least one storage device storing a set of instructions, and at least one processor in communication with the storage device. When executing the set of instructions, the at least one processor may be configured to cause the system to perform the method for image processing.

In still another aspect of the present disclosure, a non-transitory computer-readable medium storing at least one set of instructions is provided. The instructions, when executed by at least one processor, may cause the at least one processor to implement the method for image processing.

In still another aspect of the present disclosure, a system for image processing is provided. The system may include an obtaining module (310) configured to obtain a plurality of projection images generated at a plurality of angles; a generation module (320) configured to reconstruct, based on the plurality of projection images, a plurality of tomographic images of a plurality of slices; and a fusion module (330) configured to obtain a target image sequence based on the plurality of tomographic images of the plurality of slices, wherein the target image sequence including one or more fusion images, and the one or more fusion images are generated based on one or more tomographic images of the plurality of tomographic images corresponding to one or more slices of the plurality of slices.

In still another aspect of the present disclosure, an imaging device is provided. The imaging device may include a scanner configured to obtain a plurality of projection images generated at a plurality of angles; a reconstruction module configured to reconstruct, based on the plurality of projection images, a plurality of tomographic images of a plurality of slices; and an image processing module configured to obtain a target image sequence based on the plurality of tomographic images of the plurality of slices, wherein the target image sequence including one or more fusion images, and the one or more fusion images are generated based on one or more tomographic images of the plurality of tomographic images corresponding to one or more slices of the plurality of slices.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary application scenario of an image processing system according to some embodiments of the present disclosure;

FIG. 2 is a schematic diagram illustrating exemplary hardware and/or software components of a computing device according to some embodiments of the present disclosure;

FIG. 3 is a schematic diagram illustrating an exemplary image processing system according to some embodiments of the present disclosure;

FIG. 4 is a flowchart illustrating an exemplary process for processing an image according to some embodiments of the present disclosure;

FIG. 5 is a flowchart illustrating an exemplary process for determining a fusion image according to some embodiments of the present disclosure;

FIG. 6 is a schematic diagram illustrating a target angle in an exemplary projection image according to some embodiments of the present disclosure; and

FIG. 7 is a schematic diagram illustrating a fusion image corresponding to a slice according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The terms “comprise,” “comprises,” “comprising,” “include,” “includes,” “including,” “have,” “has,” “having,” and any variations thereof referred to in the present disclosure are intended to cover non-exclusive inclusions. For example, a process, a method, a system, a product, or a device including a series of operations or modules (units) is not limited to the operations or units listed, but may also include operations or units that are not listed, or may also include other operations or units inherent to the process, the method, the product or the device. The “a plurality of” referred to in the present disclosure refers to greater than or equal to two. “And/or” describes an association relationship of associated objects, indicating that three kinds of relationships may exist, for example, “A and/or B” may indicate that A exists alone, A and B exist simultaneously, and B exists alone. The terms “first,” “second,” “third,” and “fourth,” etc. referred to in the present disclosure are only to distinguish similar objects, and do not represent a specific order for the objects.

The flowcharts used in the present disclosure illustrate operations that systems implement according to some embodiments in the present disclosure. Relevant descriptions is provided to assist in a better understanding of medical imaging methods and/or systems. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

For DBT devices, sequential scanning may be performed at certain angles in a process of taking a breast tomographic image to obtain a set of projection data of different angles. The projection data may be used to reconstruct, through one or more corresponding algorithms, DBT tomographic images for medical diagnosis. Compared with a traditional 2D breast image, the DBT tomographic images can effectively solve a problem of tissue overlap in the 2D image, which has a significant advantage in the diagnosis of small calcification, thereby attracting more and more attentions. However, due to a large count of image frames of the DBT tomographic images, workload of a doctor who reads the images may undoubtedly increase. At the same time, a 2D plain image may be usually referred to when the tomographic images are read. The tomographic images and the 2D plain image may be cross-referenced for more accurate diagnosis. In the process, it is necessary to take the 2D plain image, which is inefficient.

Some embodiments of the present disclosure may provide an image processing method for image fusion based on a time sequence. In a process that the DBT device scans to obtain a plurality of projection images generated at a plurality of angles, and performs image reconstruction, a target image sequence including a plurality of fusion images relating to a plurality of slices may be obtained by the image processing method. Combined with the reconstructed tomographic images, the image sequence including a plurality of fusion images can help a doctor to better locate a lesion, understand relative positions and overlap of different lesions or tissues, and better interpret a patient's condition, thereby improving diagnostic efficiency and accuracy of a diagnostic result.

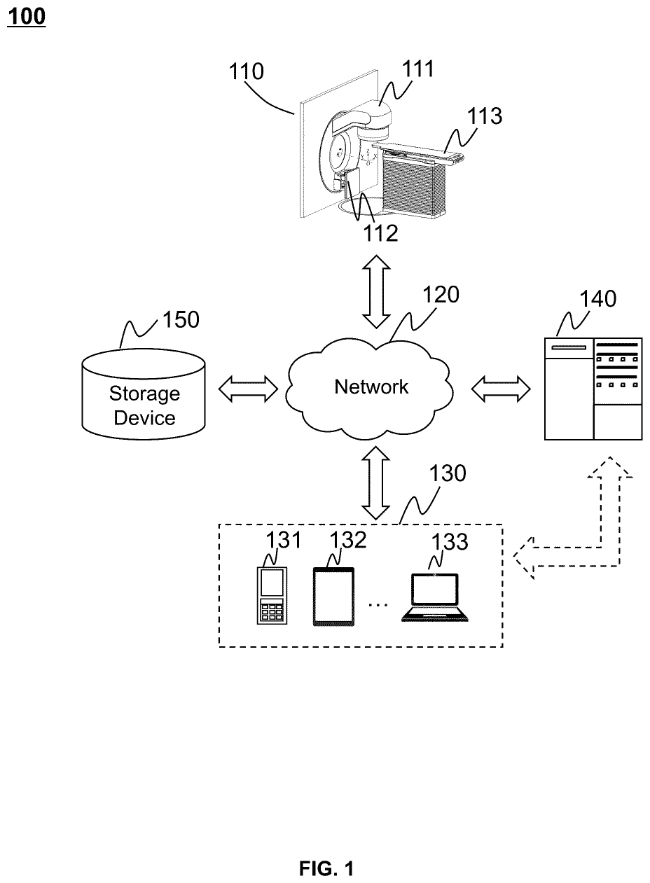

FIG. 1 is a schematic diagram illustrating an exemplary application scenario of an image processing system according to some embodiments of the present disclosure.

As shown in FIG. 1, in some embodiments, the image processing system 100 may include a scanning device 110, a network 120, a terminal 130, a processing device 140, and a storage device 150. In some embodiments, the image processing method provided in the embodiments of the present disclosure may be implemented by the image processing system 100 as shown in FIG. 1. For example, the processing device 140 may obtain, through the network 120, a plurality of projection images generated at a plurality of angles by the scanning device 110; reconstruct, based on the plurality of projection images, a plurality of tomographic images of a plurality of slices; and obtain a target image sequence including a plurality of fusion images relating to the plurality of slices by performing image fusion based on the plurality of tomographic images of the plurality of slices.

The scanning device 110 may be configured to scan a target object or a part thereof within a detection area of the scanning device, and generate scanning data relating to the target object or the part thereof. In some embodiments, the target object may include a body, a substance, or the like, or any combination thereof. In some embodiments, the target object may include a specific part of the body, such as a head, a chest, an abdomen, or the like, or any combination thereof. In some embodiments, the target object may include a specific organ, such as a heart, a breast, an esophagus, a trachea, bronchus, a stomach, a gallbladder, a small intestine, a colon, a bladder, a ureter, a uterine, a tubal, etc. In some embodiments, the target object may include a patient or other medical experimental objects (e.g., other animals such as a mouse for experiment).

In some embodiments, the scanning device 110 may include an X-ray scanner or a computed tomography (CT) scanner. In some embodiments, the scanning device 110 may include a mammography scanner. For example, the scanning device 110 may be a digital breast tomosynthesis (DBT) device, and a contrast-enhanced digital mammography (CEDM) device, a dual-energy subtraction device, etc.

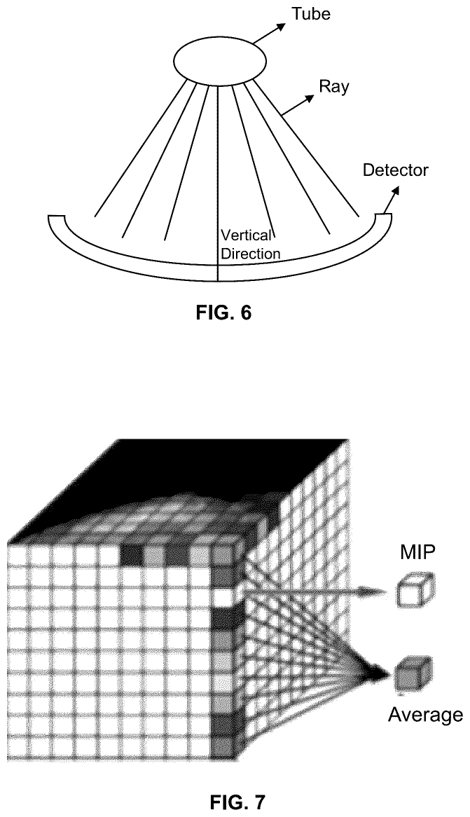

In some embodiments, the scanning device 110 may include a radiation source 111, a detector 112 and a scanning bed 113. The radiation source 111 (such as a tube shown in FIG. 6) may be configured to emit radiation beams. The detector 112 may be configured to detect radiation beams, as shown in FIG. 6. The radiation source 111 may emit radiation beams (e.g., X-rays) to the target object (e.g., a breast), and the radiation beams may be attenuated by the target object, and detected by the detector 112, thereby generating image signals. In some embodiments, the detector 112 may include one or more detector units. In some embodiments, the detector unit(s) may include single-row detector(s) and/or multi-row detector(s). In some embodiments, the detector unit(s) may include a scintillation detector (e.g., a cesium iodide detector), or other detectors, etc.

The network 120 may include any suitable network that can facilitate the exchange of information and/or data for the image processing system 100. In some embodiments, one or more components of the image processing system 100 (e.g., the scanning device 110, the terminal 130, the processing device 140, the storage device 150, etc.) may communicate information and/or data with one or more other components of the image processing system 100 via the network 120. For example, the processing device 140 may obtain projection data from the scanning device 110 through the network 120.

In some embodiments, the network 120 may include a public network (e.g., the Internet), a private network (e.g., a local area network (LAN), a wide area network (WAN)), etc.), a wired network (e.g., an Ethernet network), a wireless network (e.g., an 802.11 network, a Wi-Fi network, etc.), a cellular network (e.g., a Long Term Evolution (LTE) network), a frame relay network, a virtual private network (VPN), a satellite network, a telephone network, routers, hubs, server computers, and/or any combination thereof. In some embodiments, the network 120 may include one or more network access points. For example, the network 120 may include wired and/or wireless network access points such as base stations and/or internet exchange points through which one or more components of the image processing system 100 may be connected to the network 120 to exchange data and/or information.

In some embodiments, the terminal 130 may interact with other components in the image processing system 100 via the network 120. For example, the terminal 130 may send one or more control instructions to the scanning device 110 via the network 120 to control the scanning device 110 to scan the target object according to the instructions. As another example, the terminal 13 may receive an image sequence including a plurality of fusion images determined by the processing device 140 via the network 120, output and display the image sequence to a doctor for diagnosis.

In some embodiments, the terminal 130 may include a mobile device 131, a tablet computer 132, a laptop computer 133, or the like, or any combination thereof. For example, the mobile device 131 may include a smart home device, a wearable device, a mobile device, a virtual reality device, an augmented reality device, or the like, or any combination thereof.

In some embodiments, the terminal 130 may be part of the processing device 140. In some embodiments, the terminal 130 may be integrated with the processing device 140 as a console for the scanning device 110. For example, a user/operator (e.g., a doctor or a nurse) of the image processing system 100 may control the operation of the scanning device 110 through the console, for example, scan the target object, control the scanning bed 113 to move, etc.

The processing device 140 may process data and/or information obtained from the scanning device 110, the terminal 130 and/or the storage device 150. For example, the processing device 140 may process a plurality of projection images generated at a plurality of angles by the scanning device 110 to obtain a target image sequence including a plurality of fusion images relating to the plurality of slices.

In some embodiments, the processing device 140 may be a single server or a server group. The server group may be centralized or distributed. In some embodiments, the processing device 140 may be local or remote. For example, the processing device 140 may access information and/or data from the scanning device 110, the terminal 130, and/or the storage device 150 via the network 120. As another example, the processing device 140 may be directly connected to the scanning device 110, the terminal 130, and/or the storage device 150 to access information and/or data.

In some embodiments, the processing device 140 may be implemented on a cloud platform. For example, the cloud platform may include a private cloud, a public cloud, a hybrid cloud, a community cloud, a distributed cloud, an inter-cloud, a multi-cloud, or the like, or any combination thereof.

The storage device 150 may store data, instructions and/or any other information. In some embodiments, the storage device 150 may store data obtained from scanning device 110, the terminal 130, and/or the processing device 140. For example, the storage device 150 may store a plurality of projection images generated at a plurality of angles, etc., obtained from the scanning device 110. In some embodiments, the storage device 150 may store data and/or instructions that the processing device 140 may execute or use to perform exemplary methods described in the present disclosure.

In some embodiments, the storage device 150 may include a mass storage, a removable storage, a volatile read-and-write memory, a read-only memory (ROM), or the like, or any combination thereof. The mass storage may include a magnetic disk, an optical disk, a solid-state drive, a removable storage device, etc. The removable storage may include a flash drive, a floppy disk, an optical disk, a memory card, a zip disk, a magnetic tape, etc. The volatile read-and-write memory may include a random access memory (RAM). In some embodiments, the storage device 150 may be implemented through the cloud platform described in the present disclosure.

In some embodiments, the storage device 150 may be connected to the network 120 to communication with one or more components of the image processing system 100 (e.g., the scanning device 110, the terminal 130, the processing device 140, etc.). One or more components of the image processing system 100 may assess the data or instructions stored in the storage device 150 via the network 120. In some embodiments, the storage device 150 may be a part of the processing device 140, or may be independent, and directly or indirectly connected to the processing device 140.

It should be noted that the above description of the image processing system 100 is merely provided for the purpose of illustration, and is not intended to limit the scope of the present disclosure. For persons having ordinary skills in the art, a plurality of variations and modifications may be made under the teachings of the present disclosure. However, those variations and modifications do not depart from the scope of the present disclosure. For example, the scanning device 110, the terminal 130 and the processing device 140 may share a storage device 150, or may have their own storage devices.

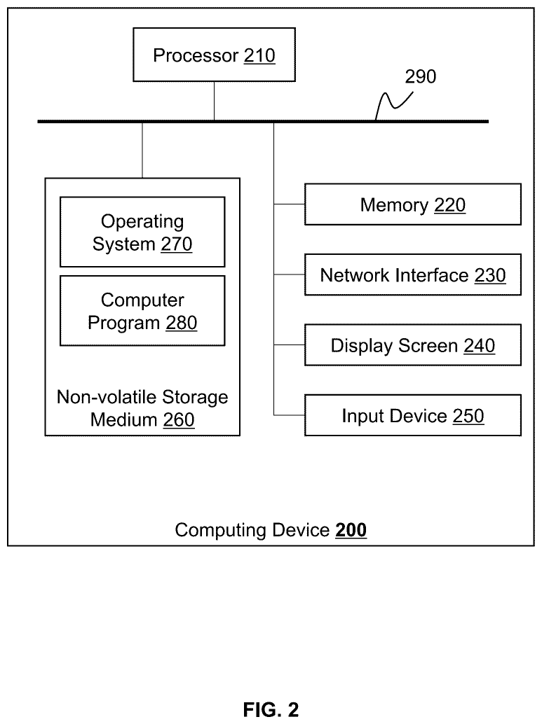

FIG. 2 is a schematic diagram illustrating exemplary hardware and/or software components of a computing device according to some embodiments of the present disclosure.

The image processing method (e.g., a process 400, a process 500) provided in the embodiments of the present disclosure may be implemented by the computing device 200 shown in FIG. 2. In some embodiments, one or more components of the image processing system 100 may be implemented by the computing device 200. For example, the scanning device 110, the terminal 130 and/or the processing device 140 may be implemented by the computing device 200.

As shown in FIG. 2, in some embodiments, the computing device 200 may include a processor 210 and storages connected via a system bus 290. In some embodiments, computer instructions may be stored in the storages. The processor 210 may execute computer instructions (e.g., program code) to implement the image processing method described in the present disclosure. In some embodiments, the computer instructions may include a program (e.g., a computer program 280), an object, a component, a data structure, a procedure, a module, and a function (a particular function described herein).

In some embodiments, the processor 210 may include a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device, any circuit or processor capable of executing one or more functions, or the like, or any combinations thereof. Merely for illustration, only one processor is described in the computing device 200. However, it should be noted that the computing device 200 in the present disclosure may also include a plurality of processors.

In some embodiments, the storages of the computing device 200 may include a non-volatile storage medium 260 and a memory 220. The non-volatile storage medium 260 may store an operating system 270 and a computer program 280. The memory 220 may provide an environment for execution of the operating system 270 and the computer program 280 in the non-volatile storage medium 260.

In some embodiments, the bus 290 may include a data bus, an address bus, a control bus, an expansion bus, and a local bus. In some embodiments, the bus 290 may include an accelerated graphics port (AGP), other graphics bus, an extended industry standard architecture (EISA) bus, a front side bus (FSB), a hyper transport (HT) interconnect, an industry standard architecture (ISA) bus, a InfiniBandinter connect, a low pin count (LPC) bus, a storage bus, a micro channel architecture (MCA), a peripheral component interconnect (PCI) bus, a PCI-express (PCI-X) bus, a serial advanced technology attachment (SATA) bus, a video electronics standards association local bus (VLB), or the like, or any combination thereof. In some embodiments, the bus 290 may include one or more buses. Although the embodiments of the present disclosure describe and illustrate a specific bus, the present disclosure considers any suitable bus or interconnect.

In some embodiments, the computing device 200 may include a network interface 230, a display screen 240 and an input device 250.

The network interface 230 may be configured to be connected with an external terminal (e.g., the terminal 130, the storage device 150) via the network. The connection may be a wired connection, a wireless connection, any other communication connection In some embodiments, the network interface 230 may be and/or include a standardized communication port, such as RS232, RS485, etc. In some embodiments, the network interface 230 may be a specially designed port. For example, the network interface 230 may be designed in accordance with the digital imaging and communications in medicine (DICOM) protocol.

The display screen 240 and the input device 250 may be configured to input or output signals, data or information. In some embodiments, the display screen 240 and the input device 250 may allow a user to communicate with a component (e.g., the scanning device 110) in the image processing system 100. Exemplary display screens 240 may include a liquid crystal display (LCD), a light-emitting diode (LED)-based display, a flat panel display, a curved screen, a television device, a cathode ray tube (CRT), or the like, or a combination thereof. Exemplary input devices 250 may include a keyboard, a mouse, a touch screen, a microphone, or the like, or a combination thereof.

In some embodiments, the computing device 200 may be a server, a personal computer, a personal digital assistant, and other terminal devices (e.g., a tablet computer, a mobile phone, etc.), a cloud, or a remote server. The embodiments of the present disclosure do not limit a specific form of the computing device.

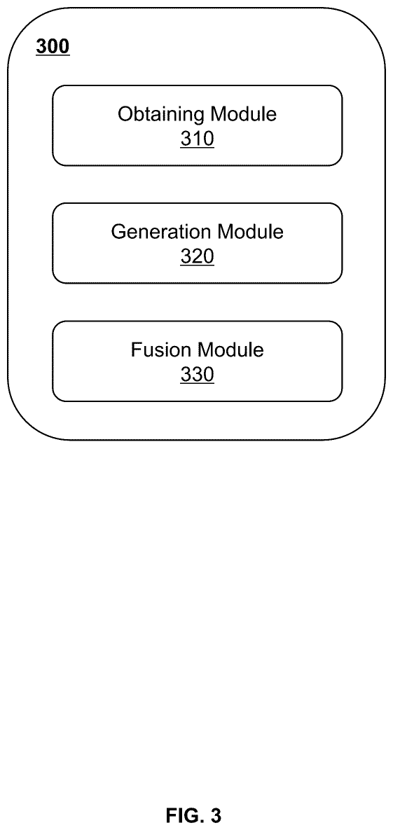

FIG. 3 is a schematic diagram illustrating an exemplary image processing system according to some embodiments of the present disclosure.

As shown in FIG. 3, in some embodiments, the image processing system 300 may include an obtaining module 310, a generation module 320, and a fusion module 330.

The obtaining module 310 may be configured to obtain a plurality of projection images generated at a plurality of angles. In some embodiments, the obtaining module 310 may process the plurality of projection images generated at the plurality of angles.

The generation module 320 may be configured to reconstruct, based on the plurality of projection images, a plurality of tomographic images of a plurality of slices. In some embodiments, the generation module 320 may reconstruct the plurality of projection images generated at different scanning angles using an image reconstruction algorithm to generate the plurality of tomographic images of the plurality of slices.

The fusion module 330 may be configured to obtain a target image sequence including a plurality of fusion images relating to the plurality of slices by performing image fusion based on the plurality of tomographic images of the plurality of slices.

In some embodiments, each fusion image of the plurality of fusion images is generated by fusing an intermediate image and a reference image corresponding to a slice of the plurality of slices. In some embodiments, for each slice of the one or more slices, the fusion module 330 may determine one or more mapping images of one or more projection images at one or more target angles of the plurality of angles in a current slice, and determine, based on the one or more mapping images, a reference image corresponding to the current slice. In some embodiments, for each slice of the one or more slices, the fusion module 330 may obtain the intermediate image corresponding to the current slice by performing a maximum intensity projection operation on the tomographic image corresponding to the current slice.

In some embodiments, the fusion module 330 may determine a weighted sum of the intermediate image of the slice and the reference image of the slice as the fusion image corresponding to the current slice.

In some embodiments, the fusion module 330 may determine, according to a generation order in which the plurality of tomographic images of the plurality of slices are generated in reconstruction, an initial slice, and designate the fusion image corresponding to the initial slice as an initial image of the target image sequence. In some embodiments, for each slice other than the initial slice in the plurality of slices, the fusion module 330 may determine one or more target slices between the initial slice and the current slice according to a positive order or a reverse order of the generation order in which the plurality of tomographic images of the plurality of slices are generated in the reconstruction. Further, the fusion module 330 may generate the target image sequence by combining one or more fusion images corresponding to the one or more target slices.

It should be understood that the systems and modules shown in FIG. 3 may be implemented in various ways. For example, in some embodiments, the imaging processing 300, or at least one of the obtaining module 310, the generation module 320, or the fusion module 330 may be implemented entirely by hardware, software, or by combining software and hardware implementation. For example, the obtaining module 310, the generation module 320, and the fusion module 330 may share a processor and a non-transitory storage medium or have their own processors and non-transitory storage mediums. The non-transitory storage medium may store a computer program. When the processor executes the computer program, a corresponding function may be implemented.

It should be noted that the above description of the image processing system 300 is merely provided for the purposes of illustration, and is not intended to limit the scope of the present disclosure. For persons having ordinary skills in the art, a plurality of variations and modifications may be made under the teachings of the present disclosure. However, those variations and modifications do not depart from the scope of the present disclosure. For example, one or more modules of the image processing system 300 may be omitted or integrated into a single module. As another example, the image processing system 300 may include one or more additional modules, such as a storage module for data storage.

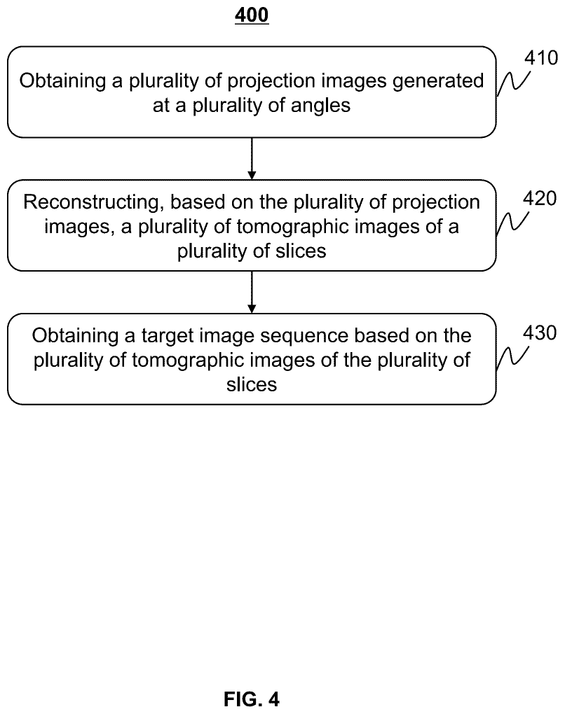

FIG. 4 is a flowchart illustrating an exemplary process for processing an image according to some embodiments of the present disclosure.

In some embodiments, the process 400 may be performed by the computing device 200. For example, the process 400 may be implemented as a set of instructions (e.g., computer programs 280) stored in a storage (e.g., the non-volatile storage medium 260, the memory 220) and assessed by the processor 210. The processor 210 may execute the set of instructions, and when executing the instructions, the processor 210 may be configured to perform the process 400. The schematic diagram of operations of the process 400 presented below is intended to be illustrative.

In some embodiments, the process 400 may be accomplished with one or more additional operations not described and/or without one or more of the operations herein discussed. Additionally, the order in which the operations of the process 400 illustrated in FIG. 4 and described below is not intended to be limiting.

In 410, a plurality of projection images generated at a plurality of angles may be obtained. In some embodiments, the operation 410 may be performed by the image processing system 100 (e.g., the processing device 140), the computing device 200 (e.g., the processor 210), or the image processing system 300 (e.g., the obtaining module 310).

In some embodiments, the plurality of projection images generated at the plurality of angles may be acquired by a DBT device.

DBT is a tomosynthesis technology that obtains tomographic images by performing reconstruction on a plurality of low-dose projection images at the plurality of angles, which can not only reduce a signal-to-noise ratio of calcification, but also overcome a problem of a traditional two-dimensional mammography molybdenum target that affects lesion observation due to tissue overlap.

In some embodiments, the plurality of angles may refer to a plurality of different scanning angles during a DBT scanning. It should be noted that the acquired plurality of projection images at different scanning angles may be a plurality of two-dimensional images. Three-dimensional tomographic images may be generated by performing reconstruction on the plurality of two-dimensional projection images at the different scanning angles.

In some embodiments, the acquired plurality of projection images at the different scanning angles may be a certain count (e.g., 15-60) of the projection images at the different scanning angles. In some embodiments, the plurality of angles may be any reasonable angles, and a difference between adjacent angles may be equal. For example, the plurality of angles may be 15 different angles a step size of 0.5 degree in −7.5˜7.5 degrees.

In some embodiments, the plurality of acquired projection images may be a plurality of projection images of a same target object at the plurality of angles. For example, the DBT device may scan a breast of a patient from the plurality of different angles to obtain a plurality of projection images of the breast at the plurality of angles. In some embodiments, the plurality of acquired projection images may be a plurality of projection images generated at the plurality of angles during a scanning process. For example, during a certain DBT scanning of a patient, the plurality of projection images may be acquired from the plurality of angles.

In some embodiments, the plurality of projection images may correspond to a plurality of sets of projection data at the plurality of angles obtained by scanning. Each set of projection data may be visualized and displayed in a form of image(s).

In some embodiments, a processing device (e.g., the processing device 140) may process the plurality of projection images generated at different scanning angles.

In some embodiments, the processing may include image segmentation, grayscale transformation, window width and window level adjustment, or the like, or any combination thereof. For example, the processing device may perform image segmentation on each projection image, and remove a non-human organ region such as air in the projection image to obtain a plurality of processed projection images.

In 420, a plurality of tomographic images of a plurality of slices may be reconstructed based on the plurality of projection images. In some embodiments, the operation 420 may be performed by the image processing system 100 (e.g., the processing device 140), the computing device 200 (e.g., the processor 210), or the image processing system 300 (e.g., the obtaining module 310).

In some embodiments, the processing device may generate tomographic images of a plurality of slices by performing reconstruction on the plurality of projection images generated at different scanning angles using one or more image reconstruction algorithms. Exemplary image reconstruction algorithms may include a filtered back projection (FBP) reconstruction algorithm, a back projection filtration (BPF) reconstruction algorithm, an iterative reconstruction algorithm, etc., which is not limited in the present disclosure. In some embodiments, the processing device may generate the tomographic images of the plurality of slices by performing reconstruction on a plurality of processed projection images. In some embodiments, the tomographic images of the plurality of slices may be generated from a top slice to a bottom slice of the target object, or from a bottom slice to a top slice of the target object. The top slice or the bottom slice may refer to a top slice or a bottom slice of the target object in a vertical direction of the plurality of scanning angles.

In 430, a target image sequence including a plurality of fusion images relating to the plurality of slices may be obtained by performing image fusion based on the plurality of tomographic images of the plurality of slices. In some embodiments, the operation 430 may be performed by the image processing system 100 (e.g., the processing device 140), the computing device 200 (e.g., the processor 210), or the image processing system 300 (e.g., the obtaining module 310).

In some embodiments, each fusion image of the plurality of fusion images may be generated by fusing an intermediate image corresponding to a slice of the plurality of slices and a reference image corresponding to the slice.

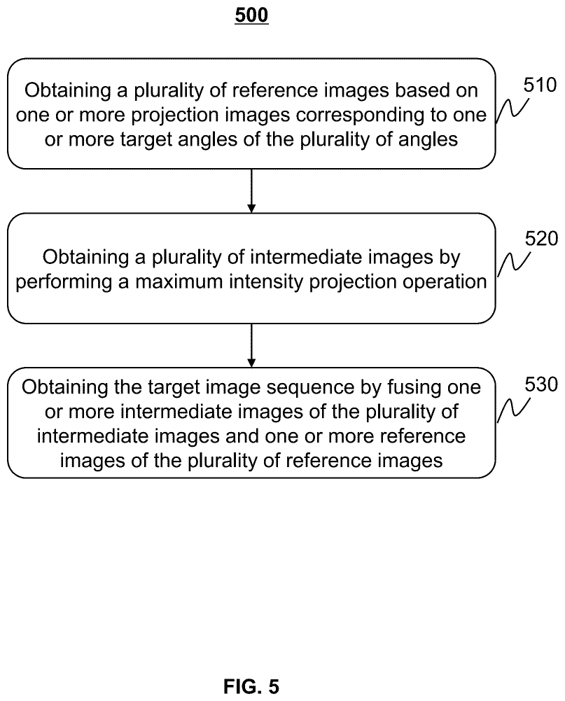

In some embodiments, the reference image corresponding to the slice may be obtained based on one or more projection images corresponding to one or more target angles of the plurality of angles. In some embodiments, the intermediate image corresponding to the slice may be obtained by performing a maximum intensity projection operation on the tomographic image corresponding to the slice. More descriptions regarding obtaining the fusion images may be found in FIG. 5 and description thereof, which will not be repeated herein.

In some embodiments, the fusing process of the one or more tomographic images of the plurality of tomographic images corresponding to the one or more slices of the plurality of slices may be performed simultaneously with the reconstructing process of the plurality of tomographic images of the plurality of slices. Merely by way of example, when an image is reconstructed, after a tomographic image of a first slice is generated, a reference image and an intermediate image of the first slice may be determined. A first fusion image corresponding to the first slice may be obtained based on the reference image of the first slice and the intermediate image of the first slice. Further, after a second tomographic image of a second slice is generated, a second reference image of the second slice and a second intermediate image of the second slice may be determined. A second fusion image corresponding to the second slice may be obtained based on the second reference image and the second intermediate image. In some embodiments, the fusing process of the one or more tomographic images of the plurality of tomographic images corresponding to the one or more slices of the plurality of slices may be performed after the reconstructing process of the plurality of tomographic images of the plurality of slices.

In some embodiments, the target image sequence may include one or more fusion images corresponding to the one or more slices of the plurality of slices. Each fusion image may be a 2D image corresponding to a slice. For example, when ten tomographic images are obtained by reconstruction, the target image sequence may be ten fusion images corresponding to ten 10 slices one by one. For another example, when tomographic images of ten slices are obtained by reconstruction, the target image sequence may be 5 fusion images. Each fusion image may correspond to 5 successive slices of the 10 slices (e.g., a first slice to a 5th slice, a second slice to a 6^{th} slice, or a 6^{th} slice to a 10^{th} slice, etc.) one by one. In some embodiments, a count of slices corresponding to a plurality of fusion images included in the target image sequence may be determined as any one or more successive slices according to actual needs, which is not limited in the present disclosure.

In some embodiments, the obtained target image sequence may be played in a video-like form. That is, the obtained target image sequence including a plurality of fusion images may be images that can be dynamically displayed in a form of animation according to a generation sequence of the plurality of tomographic images during reconstruction, which may also be called a fusion timing diagram. For example, if the generated tomographic images include 10 images, the processing device may obtain a fusion image corresponding to each slice of 10 slices according to the generation sequence of the 10 tomographic images during reconstruction, thereby obtaining the fusion timing diagram.

In the above image processing method, the target image sequence including the plurality of fusion images relating to the plurality of slices may be obtained according to the plurality of projection images at different scanning angles, which can reflect changes of each fusion image, and help a doctor to see dynamic change information of each slice, thereby, accurately and quickly determining a position of a slice where a lesion is located, avoiding leaking a lesion, and improving diagnostic efficiency and accuracy of a diagnostic results.

FIG. 5 is a flowchart illustrating an exemplary process for determining a fusion image according to some embodiments of the present disclosure.

In some embodiments, the process 500 may be performed by the computing device 200. For example, the process 500 may be implemented as a set of instructions (e.g., computer programs 280) stored in a storage (e.g., the non-volatile storage medium 260, the memory 220) and assessed by the processor 210. The processor 210 execute the set of instructions, and when executing the instructions, the processor 210 may be configured to perform the process 500. The schematic diagram of operations of the process 500 presented below is intended to be illustrative. In some embodiments, the process 500 may be accomplished with one or more additional operations not described and/or without one or more of the operations herein discussed. Additionally, the order in which the operations of the process 500 illustrated in FIG. 5 and described below is not intended to be limiting.

In 510, a plurality of reference images may be obtained based on one or more projection images corresponding to one or more target angles of the plurality of angles.

In some embodiments, for each slice of the plurality of slices, a reference image corresponding to the slice may be obtained based on one or more projection images corresponding to one or more target angles of the plurality of angles. The one or more target angles may include a first angle corresponding to a vertical direction of the plurality of slices, a second angle and a third angle. The second angle may be a left adjacent angle of the first angle. The third angle may be a right adjacent angle of the first angle. For example, as shown in FIG. 6, an example of the vertical angle (i.e., the first angle) of the embodiment is shown in the figure. For example, if the plurality of scanning angles include 15 angles with a step size of 0.5 degree in a range of −7.5˜7.5 degrees, the first angle corresponding to the vertical direction of each slice may be 0 degree. The second angle (i.e., a left adjacent angle of the first angle) may be −0.5 degrees. The third angle (i.e., a right adjacent angle of the first angle) may be 0.5 degrees.

It should be understood that the first angle, the second angle, and third angle are only illustrated as an example of the target angles. In some embodiments, a target angle may be relating to an acquisition angle of each projection image. In other words, the target angle may change with a change of the acquisition angle of each projection image. The acquisition angles of different projection images may correspond to different target angles. The processing device may determine the target angle according to the acquisition angle of each projection image. For example, the one or more target angles may include three or more middlemost angles of the plurality of scanning angles, or any three or more angles of the plurality of scanning angles.

In some embodiments, for each slice of the plurality of slices, the processing device may determine one or more mapping images of the one or more projection images at the one or more target angles in the slice. In some embodiments, the processing device may determine the one or more mapping images of the one or more projection images at the one or more target angles in the corresponding slice using a filtering and/or a back-projection algorithm. The one or more mapping images may reflect a state of the current slice at different angles.

Merely by way of example, for each slice, the processing device may respectively determine a mapping image A of a projection image at the first angle in the current slice, a mapping image B of a projection image at the second angle in the current slice, and a mapping image C of a projection image at the third angle in the current slice using the filtering and/or the back-projection algorithm.

Further, for each slice, the processing device may determine, based on the one or more mapping images, a reference image corresponding to the slice. In some embodiments, the processing device may determine an average image or a weighted image of the one or more mapping images as the reference image corresponding to the slice. In some embodiments, as shown in FIG. 7, the processing device may determining an average value or a weighted sum of one or more pixel values of one or more pixels at a same position in the one or more mapping images, and designate the average value or the weighted sum as a pixel value of a pixel at the same position in the reference image to obtain the reference image corresponding to the slice.

Merely by way of example, for each slice, the processing device may determine, according to pixel values of pixels at a same position in the mapping image A, the mapping image B, and the mapping image C, an average pixel value at the position, designate the average pixel value as a pixel value of a pixel at the position in the reference image. The processing device may traverse pixels of each position in the mapping image(s) to obtain the reference image corresponding to the slice.

Alternatively, the processing device may perform weighed summation of pixel values of pixels at a same position in the mapping image A, the mapping image B, and the mapping image C to determine a pixel weighted sum at the position, designate the pixel weighted sum as a pixel value of a pixel at the position in the reference image, and traverse pixels of each position in the mapping image(s) to obtain the reference image corresponding to the slice.

In some embodiments, the weighed summation of pixel values of pixels at a same position in a plurality of mapping images may be in any ratio, such as 1:1:1, 1:2:1, etc., which is not limited herein.

In some embodiments, an image including the average values or the weighted sums of each slice, i.e., the reference image, may be accurately obtained by using the projection images at the one or more target angles, and each fused image may be obtained accurately, which can improve accuracy of the obtained fusion image.

In 520, a plurality of intermediate images may be obtained by performing a maximum intensity projection operation.

In some embodiments, for each slice, the processing device may determine an intermediate image corresponding to the current slice by performing a maximum intensity projection (MIP) operation.

The MIP is an image post-processing technique that obtains a two-dimensional image using a perspective method, that is, a technique that generates an image by calculating a pixel or voxel with a maximum intensity along each ray of the scanned object. When a beam of light passes through an original image of a piece of tissue, a pixel or voxel with a maximum intensity in the image may be retained and projected onto a two-dimensional plane, and an MIP reconstruction image may be generated. The MIP image may reflect X-ray attenuation values of corresponding pixels or voxels, and relatively small intensity changes may also be reflected by the MIP image, and thus, stenosis, expansion, and filling defects of blood vessels may be well displayed, and calcification on a blood vessel wall may be distinguished from a contrast agent in a blood vessel lumen, etc.

In some embodiments, for each slice, the processing device may determine an intermediate image corresponding to the current slice by performing an MIP operation on the tomographic image corresponding to the current slice. Merely by way of example, assuming that there are 50 tomographic images, and the current slice is a 20^{th} slice, the processing device may perform a maximum intensity projection on all the tomographic images corresponding to the first slice to the 20^{th} slice, determine a corresponding maximum intensity projection image, and designate the maximum intensity projection image as an intermediate image corresponding to the 20^{th} slice.

In some embodiments, according to a positive order or a reverse order of the generation order in which the plurality of tomographic images of the plurality of slices are generated in the reconstruction, for a current slice other than the initial slice in the plurality of slices, an intermediate image corresponding to the current slice may be obtained by fusing an intermediate image corresponding to a previous slice of the current slice and a maximum intensity projection image corresponding to the current slice.

In some embodiments, for a current slice other than the initial slice in the plurality of slices, the processing device may determine the current slice as a updated initial slice, and obtain a maximum intensity projection image corresponding to the current slice by performing a maximum intensity projection operation on the tomographic image corresponding to the updated initial slice. Further, an intermediate image corresponding to a previous slice of the current slice may be determined, the processing device may obtain the intermediate image corresponding to the current slice by fusing the intermediate image corresponding to the previous slice and the maximum intensity projection image corresponding to the updated initial slice. For example, the current slice is a 10^{th} slice, the processing device may determine the 10^{th} slice as a updated initial slice, and obtain a corresponding maximum intensity projection image by performing a maximum intensity projection operation on the tomographic image corresponding to the updated initial slice individually. Further, the processing device may obtain the intermediate image corresponding to the 10^{th} slice by fusing the intermediate image corresponding to the 9^{th} slice and the maximum intensity projection image corresponding to the updated initial slice.

Since intermediate image calculation is performed on the previous slice of the current slice, the intermediate image corresponding to the previous slice may be an MIP image of the tomographic images corresponding to all slices between the previous slice and the initial slice, that is, an MIP operation may have been performed on the tomographic images corresponding to all slices between the previous slice and the initial slice, the current slice as a updated initial slice, the maximum intensity projection operation may be performed on the tomographic image corresponding to the updated initial slice.

In 530, the target image sequence may be obtained by fusing one or more intermediate images of the plurality of intermediate images and one or more reference images of the plurality of reference images.

In some embodiments, for each slice, the processing device may determine, based on the intermediate image of the slice and the reference image of the slice, a fusion image corresponding to the slice. In some embodiments, for each slice, the processing device may determine a weighted sum of the intermediate image of the slice and the reference image of the slice as the fusion image corresponding to the slice. In some embodiments, the intermediate image and the reference image may be fused according to a preset ratio to obtain the intermediate image. The preset ratio may be a superposition ratio of the intermediate image to the reference image, such as 1:1, or 1:2, etc., which is not limited herein.

In some embodiments, the processing device may determine, according to a generation order in which the plurality of tomographic images of the plurality of slices are generated in reconstruction, an initial slice, and designate the fusion image corresponding to the initial slice as an initial image of the target image sequence.

In some embodiments, a slice corresponding to a tomographic image that is generated earliest or latest in reconstruction of the tomographic images of the plurality of slices may be determined as the initial slice. For example, if a plurality of tomographic images of a breast are reconstructed sequentially from a top slice to a bottom slice, a first slice (i.e., the top slice) or a last slice (i.e., the bottom slice) may be designated as the initial slice. In some embodiments, any one of a plurality of slices of a target object may be designated as a top slice or a bottom slice of the target object. Assuming that the target object is divided into 100 slices in a vertical direction of a scanning angle (such as the direction perpendicular to the scanning angle in FIG. 6), a first slice from top to bottom may be designated as the top slice, a second slice may be designated as the top slice, a 50^{th} slice may be designated as the top slice, or an 80^{th} slice may be designated as the top slice. Accordingly, a 10^{th} slice of one hundred slices from top to bottom may be designated as the bottom slice, the 80^{th} slice may be designated as the bottom slice, or the 100^{th} slice may be designated as the bottom slice, etc. It is worth noting that the top slice mentioned here may be above the bottom slice.

In some embodiments, a slice corresponding to a tomographic image generated in any reconstruction of the tomographic images of the plurality of slices may be determined as the initial slice according to actual requirements. For example, if a doctor wants to focus on clinical observation of a 2D image corresponding to the 10^{th} slice, then the 10^{th} slice of the plurality of slices may be determined as the initial slice.

In some embodiments, according to a positive order or a reverse order of the generation order in which the plurality of tomographic images of the plurality of slices are generated in the reconstruction, for a current slice other than the initial slice in the plurality of slices, one or more target slices between the initial slice and the current slice may be determined, and the target image sequence may be generated by combining one or more fusion images corresponding to the one or more target slices.

The positive order may refer to that a generation order in which the plurality of tomographic images corresponding to the plurality of slices are generated in the fusion process is the same as the generation order in which the plurality of tomographic images corresponding to the plurality of slices are generated in the reconstruction. Accordingly, the reverse order may refer to that the generation order in which the plurality of tomographic images corresponding to the plurality of slices are generated in the fusion process and the generation order in which the plurality of tomographic images corresponding to the plurality of slices are generated in the reconstruction are reverse. For example, if a first slice corresponding to an earliest tomographic image generated in the reconstruction is determined as the initial slice, the generation order in which a plurality of fusion images are generated in the fusion process may be positive order. Accordingly, if a last slice corresponding to a latest tomographic image generated in the reconstruction is determined as the initial slice, the generation order in which the plurality of fusion images in the fusion process may be a reverse order.

In some embodiments, all slices between the initial slice and the current slice may be designated as the one or more target slices. For example, if the initial slice is a first slice and the current slice is a 5^{th} slice, the target slices may be slices between the first slice to the 5^{th} slice, a total of 5 slices.

In some embodiments, one or more slices between the initial slice and the current slice may be designated as the one or more target slices, and a count of the one or more slices may not exceed a preset number. The preset number may be used to limit a maximum superposition count of fusion images. For example, the preset number may be 5, 10, 20, etc. In some embodiments, the preset number may be determined according to clinical needs. For example, the preset number of fusion images that need to be superimposed may be determined according to needs of a doctor in image reading.

In some embodiments, all slices of the plurality of slices may be designated as the one or more target slices. In some embodiments, one or more slices of the plurality of slices may be designated as the one or more target slices, and a count of the one or more slices may not exceed a preset number. Merely by way of example, it is assumed that there are 50 tomographic images generated, and the preset number is 10. If the initial slice is a 10^{th} slice, slices between a 11^{th} slice and the 20^{th} slice may be determined as the target slices. If the initial slice is a 2^{th} slice, slices between a 2^{th} slice and the 11^{th} slice may be determined as the target slices.

In some embodiments, the one or more target slices may be determined according to the preset number, and then the fusion images corresponding to the preset number of slices may be determined, which can flexibly determine a count of images that need to be superimposed according to actual needs, and improve flexibility of the obtained timing diagram of the fusion images (i.e., the target image sequence including a plurality of fusion images).

It should be noted that whether to designate all slices of the plurality of slices as the one or more target slices or designate one or more slices of the plurality of slices as the one or more target slices, a count of the one or more slices may not exceed a preset number, and the target slices may be one or more successive slices.

It can be understood that with increase of tomographic images, the fusion images corresponding to each slice may have also been updated until a new fusion image is obtained. Finally, when the fusion images corresponding to all slices are generated, an image sequence including a plurality of fusion images may be obtained. It should be noted that whether the fused images corresponding to each slice are determined according to the positive order of the generation order in which the plurality of tomographic images are generated in the reconstruction, or the fused images corresponding to each slice are determined according to the reverse order, it is necessary to ensure that the fusion calculation is performed according to a consecutive generation order of each tomographic image in the reconstruction.

In some embodiments, a plurality of fusion images corresponding to a plurality of slices may be sent to a display device (e.g., the terminal 130) to be displayed to a user. In some embodiments, a plurality of tomographic images corresponding to a plurality of slices may be sent to a display device (e.g., the terminal 130) to be displayed to a user. In some embodiments, the image sequence including a plurality of fusion images corresponding to a plurality of slices (e.g., an image sequence including a plurality of fusion images obtained based on a plurality of tomographic images) may be sent to an output device (e.g., the terminal 130) to be displayed to a user.

It should be noted that the above description of the process 400 and the process 500 is merely provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure.

Some embodiments of the present disclosure provide a computer device including a storage and a processor. A computer program may be stored in the storage, and the processor may implement the process 400 and/or the process 500 when the computer program is executed.

Some embodiments of the present disclosure provide a computer-readable storage medium storing a computer program. When executed by a processor, the computer program may implement the process 400 and/or the process 500.

The implementation principles and technical effects of the computer device and the computer-readable storage medium provided by the embodiments may be similar to those of the embodiments of the process 400 and the process 500, which are not repeated herein again.

In the image processing methods and systems provided in some embodiments in the present disclosure, by obtaining the plurality of tomographic images for medical diagnosis according to the plurality of projection images at the plurality of scanning angles, obtaining the plurality of reference images according to the mapping images of the target angles in each projection image, and obtaining the plurality of intermediate images, the target image sequence including a plurality of fusion images relating to the plurality of slices may be obtained. The generated tomographic image is a three-dimensional image, a fusion image is obtained based on the intermediate image of the tomographic image and the reference image, and the fusion image is a two-dimensional image. Accordingly, the fusion image sequence is a timing diagram of the two-dimensional images. When two-dimensional images need to be referred to medical diagnosis using a three-dimensional tomographic image, a better diagnostic reference purpose may be achieved by browsing the timing diagram of the two-dimensional images, which can reduce an imaging process of the two-dimensional image and improve efficiency of doctor's image reading.

It should be noted that different embodiments may have different beneficial effects. In different embodiments, the possible beneficial effects may include any combination of one or more of the above, or any other possible beneficial effects that may be obtained.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A method implemented on at least one machine each of which has at least one processor and at least one storage device for image processing, comprising:
obtaining a plurality of projection images generated at a plurality of angles;
reconstructing, based on the plurality of projection images, a plurality of tomographic images of a plurality of slices; and
obtaining a target image sequence based on the plurality of tomographic images of the plurality of slices, wherein the target image sequence including one or more fusion images, and the one or more fusion images are generated based on one or more tomographic images of the plurality of tomographic images corresponding to one or more slices of the plurality of slices.

2. The method of claim 1, wherein each fusion image of the one or more fusion images is generated by fusing an intermediate image corresponding to a slice of the one or more slices and a reference image corresponding to the slice.

3. The method of claim 2, wherein obtaining the one or more fusion images includes:
for each slice of the one or more slices,
determining one or more mapping images of one or more projection images at one or more target angles of the plurality of angles in the slice;
determining, based on the one or more mapping images, a reference image corresponding to the slice; and
determining, based on the intermediate image of the slice and the reference image of the slice, a fusion image corresponding to the slice.

4. The method of claim 3, wherein the determining, based on the one or more mapping images, a reference image corresponding to the slice includes:
determining an average value or a weighted sum of one or more pixel values of one or more pixels at a same position in the one or more mapping images; and
designating the average value or the weighted sum as a pixel value of a pixel at the same position in the reference image.

5. The method of claim 3, wherein the determining, based on the intermediate image of the slice and the reference image of the slice, a fusion image corresponding to the slice includes:
determining an image generated by fusing the intermediate image of the slice and the reference image of the slice according to a preset ratio as the fusion image corresponding to the slice.

6. The method of claim 3, wherein the determining one or more mapping images of one or more projection images at one or more target angles of the plurality of angles in the slice includes:
determining the one or more mapping images of the one or more projection images at the one or more target angles in the slice using a filtering and/or a back-projection algorithm.

7. The method of claim 2, wherein obtaining the target image sequence includes:
determining, according to a generation order in which the plurality of tomographic images of the plurality of slices are generated in reconstruction, an initial slice; and
designating the fusion image corresponding to the initial slice as an initial image of the target image sequence.

8. The method of claim 7, wherein the determining, according to a generation order in which the plurality of tomographic images of the plurality of slices are generated in reconstruction, an initial slice includes:
designating a slice corresponding to a tomographic image generated earliest or latest in the reconstruction of the plurality of tomographic images of the plurality of slices as the initial slice.

9. The method of claim 8, wherein obtaining the target image sequence further includes:
according to a positive order or a reverse order of the generation order in which the plurality of tomographic images of the plurality of slices are generated in the reconstruction, for a current slice other than the initial slice in the plurality of slices,
determining one or more target slices between the initial slice and the current slice; and
generating the target image sequence by combining one or more fusion images corresponding to the one or more target slices.

10. The method of claim 9, wherein the determining one or more target slices between the initial slice and the current slice includes:
designating all slices between the initial slice and the current slice as the one or more target slices; or
designating one or more slices between the initial slice and the current slice as the one or more target slices, a count of the one or more slices being not exceeding a preset number.

11. The method of claim 2, wherein determining the one or more intermediate images includes:
for each slice of the one or more slices,
obtaining the intermediate image corresponding to the current slice by performing a maximum intensity projection operation on the tomographic image corresponding to the current slice.

12. The method of claim 2, wherein determining the one or more intermediate images includes:
for each slice of the one or more slices,
determining the current slice as an updated initial slice;
obtaining a maximum intensity projection image corresponding to the current slice by performing a maximum intensity projection operation on the tomographic image corresponding to the updated initial slice;
obtaining the intermediate image corresponding to a previous slice of the current slice; and
obtaining the intermediate image corresponding to the current slice by fusing the intermediate image corresponding to the previous slice and the maximum intensity projection image corresponding to the updated initial slice.

13. The method of claim 3, wherein the one or more target angles include a first angle corresponding to a vertical direction of the plurality of slices, a second angle and a third angle, the second angle being a left adjacent angle of the first angle, the third angle being a right adjacent angle of the first angle.

14. The method of claim 1, wherein the plurality of projection images are acquired by a digital breast tomosynthesis (DBT) device.

15. The method of claim 1, further comprising:
processing the plurality of projection images.

16. The method of claim 15, wherein the processing includes at least one of image segmentation, grayscale transformation, or window width and window level adjustment.

17. The method of claim 1, wherein the fusing process of the one or more tomographic images of the plurality of tomographic images corresponding to the one or more slices of the plurality of slices is performed simultaneously with the reconstructing process of the plurality of tomographic images of the plurality of slices.

18. (canceled)

19. A non-transitory computer readable medium storing instructions, the instructions, when executed by at least one processor, causing the at least one processor to implement a method comprising:
obtaining a plurality of projection images generated at a plurality of angles;
reconstructing, based on the plurality of projection images, a plurality of tomographic images of a plurality of slices; and
obtaining a target image sequence based on the plurality of tomographic images of the plurality of slices, wherein the target image sequence including one or more fusion images, and the one or more fusion images are generated based on one or more tomographic images of the plurality of tomographic images corresponding to one or more slices of the plurality of slices.

20. (canceled)

21. An imaging device, comprising:
a scanner configured to obtain a plurality of projection images generated at a plurality of angles;
a reconstruction module configured to reconstruct, based on the plurality of projection images, a plurality of tomographic images of a plurality of slices; and
an image processing module configured to obtain a target image sequence based on the plurality of tomographic images of the plurality of slices, wherein the target image sequence including one or more fusion images, and the one or more fusion images are generated based on one or more tomographic images of the plurality of tomographic images corresponding to one or more slices of the plurality of slices.

22. The device of claim 21, wherein each fusion image of the one or more fusion images is generated by fusing an intermediate image corresponding to a slice of the one or more slices and a reference image corresponding to the slice.
